(19) United States
(12) Patent Application Publication
(10) Pub. No.: US 2026/0261346 A1
(43) Pub. Date: Sep. 3, 2026

(54) COMMUNICATION SYSTEM, ESTIMATION APPARATUS AND ESTIMATION METHOD

(71) Applicant: NTT, Inc., Tokyo (JP)

(72) Inventors: Akira KAWAI, Musashino-shi (JP); Masanori NAKAMURA, Musashino-shi (JP); Takayuki KOBAYASHI, Musashino-shi (JP); Yutaka MIYAMOTO, Musashino-shi (JP)

(73) Assignee: NTT, Inc., Tokyo (JP)

(21) Appl. No.: 18/865,388

(22) PCT Filed: Jun. 9, 2022
(86) PCT No.: PCT/JP2022/023299

§ 371 Date: Nov. 13, 2024

(51) Int. Cl. H04B 10/516; H04B 10/079; H04B 10/2507

(52) U.S. Cl. CPC H04B 10/516; H04B 10/079; H04B 10/2507

(57) ABSTRACT

In a communication system, a transmission device includes a first modulation unit that outputs an optical signal for which modulation processing has been executed to an optical transmission line. A reception device includes a first adaptive filter configured to execute first filter processing for a first reception signal including noise generated in the optical signal in the optical transmission line, a demodulation unit configured to execute demodulation processing for the first reception signal for which the first filter processing has been executed, a second modulation unit configured to execute the modulation processing for a second reception signal obtained as a result of the demodulation processing for the first reception signal for which the first filter processing has been executed, a second adaptive filter configured to update a tap coefficient of the second filter processing such that a result obtained by executing second filter processing for the second reception signal for which the modulation processing has been executed matches the first reception signal including the noise, and an estimation unit configured to estimate at least one of a differential group delay or a polarization dependent loss of the first reception signal on a basis of the updated tap coefficient.

### TECHNICAL FIELD

The present invention relates to a communication system, an estimation apparatus and an estimation method.

### BACKGROUND ART

Communication using an optical signal transmitted through an optical fiber has broadband characteristics and low loss characteristics. For this reason, the communication using an optical signal is widely used as one of methods for realizing modern long-distance and large-capacity communication. Polarization mode dispersion (PMD) and polarization dependent loss (PDL) are known as factors that limit a transmission capacity of the optical signal in an optical transmission line (optical transmission system) using an optical fiber.

Waveform distortion caused in the optical signal due to the polarization mode dispersion is quantified using an index called differential group delay (DGD). An influence of the polarization mode dispersion and the polarization dependent loss on the waveform distortion can be reduced by an adaptive filter in a digital signal processing circuit of the reception device. Here, the greater the influence of the polarization mode dispersion and the polarization dependent loss on the waveform distortion, the higher the possibility of failing to compensate for the waveform distortion.

Therefore, the differential group delay and the polarization dependent loss of the optical transmission line are monitored so that the optical transmission line is stably operated. When an abnormality is detected in a monitoring result, necessary items among a modulation format, a modulation rate, the number of subcarriers, and a transmission route may be changed.

In recent years, a technique of spatial multiplexing transmission in which a spatial multiplexing fiber is used as an optical transmission line has been actively studied. In the spatial multiplexing fiber, a core in an optical fiber has a plurality of propagation degrees of freedom. As important indices in the spatial multiplexing transmission, the differential mode delay (DMD) that is the differential group delay (DGD) extended to dispersion between modes of the spatial multiplexing fiber and a mode dependent loss (MDL) that is the polarization dependent loss (PDL) extended to a loss difference between modes are known.

A digital coherent reception device can estimate an index value of the waveform distortion by using an adaptive filter having a multiple input multiple output (MIMO) configuration. That is, since a tap coefficient of the adaptive filter approximates an inverse function of a transfer function of an optical transmission system, it is possible to estimate the index values of the polarization mode dispersion, the polarization dependent loss, and the like on the basis of an estimation result of the tap coefficient.

In a case where a polarization multiplexed signal is transmitted through a single mode fiber, the form of the MIMO adaptive filter is a “2×2” form. In a case where an N (N is an integer of 2 or more)—multiplexed spatial multiplexed signal is transmitted, the form of the MIMO adaptive filter is an “N×N” form. In these signal transmission schemes, a dedicated device for estimating the waveform distortion is unnecessary. Therefore, there is an advantage that a state of the optical transmission line can be estimated in real time without deteriorating transmission quality of the signal.

### CITATION LIST

### Non Patent Document

Non Patent Document 1: M. Mayrock and H. Haunstein, “Performance monitoring in optical OFDM systems”. In Optical Fiber Communication Conference, p. OWM3, March 2009.

### SUMMARY OF INVENTION

### Technical Problem

The method of estimating the index values of the polarization mode dispersion, the polarization dependent loss, and the like on the basis of the estimation result of the tap coefficient has a problem that the estimation accuracy of the index values deteriorates as noise generated in the process of transmission increases. The noise generated in the process of transmission is, for example, noise of amplified spontaneous emission (ASE) of an optical amplifier.

As an estimation method capable of coping with the deterioration in the accuracy of estimating the index values of the polarization mode dispersion, the polarization dependent loss, and the like, there is an estimation method using a smoothing filter such as a Savitzky-Golay filter. In this estimation method, when the index values of the polarization mode dispersion, the polarization dependent loss, and the like are estimated, filtering processing using digital signal processing is executed for the signal, so that the noise is smoothed and the estimation accuracy is improved.

However, when spectra of the polarization mode dispersion and the polarization dependent loss before the smoothing filter processing is executed include a system error in which an average value of errors is not 0, it is not possible to improve the estimation accuracy of the polarization mode dispersion and the polarization dependent loss. In particular, in the estimation of the polarization dependent loss, in a case where a minimal mean square error (MMSE) algorithm is used to converge the tap coefficient of the adaptive filter, it is known that a system error occurs according to the amount of noise included in a reception signal. As described above, in the case where the reception signal includes noise, there is a problem that the estimation accuracy of at least one of the differential group delay or the polarization dependent loss cannot be improved.

In view of the above circumstances, an object of the present invention is to provide a communication system, an estimation device, and an estimation method capable of improving estimation accuracy of at least one of a differential group delay or a polarization dependent loss even in a case where a reception signal contains noise.

### Solution to Problem

One aspect of the present invention is a communication system including: a transmission device and a reception device, the transmission device including a first modulation unit configured to output an optical signal for which modulation processing has been executed to an optical transmission line, and the reception device including a first adaptive filter configured to execute first filter processing for a first reception signal including noise generated in the optical signal in the optical transmission line, a demodulation unit configured to execute demodulation processing for the first reception signal for which the first filter processing has been executed, a second modulation unit configured to execute the modulation processing for a second reception signal obtained as a result of the demodulation processing for the first reception signal for which the first filter processing has been executed, a second adaptive filter configured to update a tap coefficient of the second filter processing such that a result obtained by executing second filter processing for the second reception signal for which the modulation processing has been executed matches the first reception signal including the noise, and an estimation unit configured to estimate at least one of a differential group delay or a polarization dependent loss of the first reception signal on a basis of the updated tap coefficient.

One aspect of the present invention is an estimation device including: a modulation unit configured to execute the modulation processing for a second reception signal obtained as a result of the demodulation processing for the first reception signal for which the first filter processing has been executed; a second adaptive filter configured to update a tap coefficient of the second filter processing such that a result obtained by executing second filter processing for the second reception signal for which the modulation processing has been executed matches the first reception signal including the noise; and an estimation unit configured to estimate at least one of a differential group delay or a polarization dependent loss of the first reception signal on a basis of the updated tap coefficient.

One aspect of the present invention is an estimation method executed by a communication system including a transmission device and a reception device, the communication method including: by the transmission device, outputting an optical signal for which modulation processing has been executed to an optical transmission line; and by the reception device, executing first filter processing for a first reception signal including noise generated in the optical signal in the optical transmission line; executing demodulation processing for the first reception signal for which the first filter processing has been executed; executing the modulation processing for a second reception signal obtained as a result of the demodulation processing for the first reception signal for which the first filter processing has been executed; updating a tap coefficient of the second filter processing such that a result obtained by executing second filter processing for the second reception signal for which the modulation processing has been executed matches the first reception signal including the noise; and estimating at least one of a differential group delay or a polarization dependent loss of the first reception signal on a basis of the updated tap coefficient.

### Advantageous Effects of Invention

According to the present invention, even in the case where the reception signal includes noise, it is possible to improve the estimation accuracy of at least one of the differential group delay or the polarization dependent loss.

### BRIEF DESCRIPTION OF DRAWINGS

FIG. 1 is a diagram illustrating a configuration example of a communication system in a first embodiment.

FIG. 2 is a flowchart illustrating an operation example of the communication system in the first embodiment.

FIG. 3 is graphs illustrating an example of a simulation result of a differential group delay and a polarization dependent loss in the first embodiment.

FIG. 4 is a diagram illustrating a configuration example of a communication system in a second embodiment.

FIG. 5 is a diagram illustrating a hardware configuration example of a communication device in each embodiment.

### DESCRIPTION OF EMBODIMENTS

Embodiments of the present invention will be described in detail with reference to the drawings.

### First Embodiment

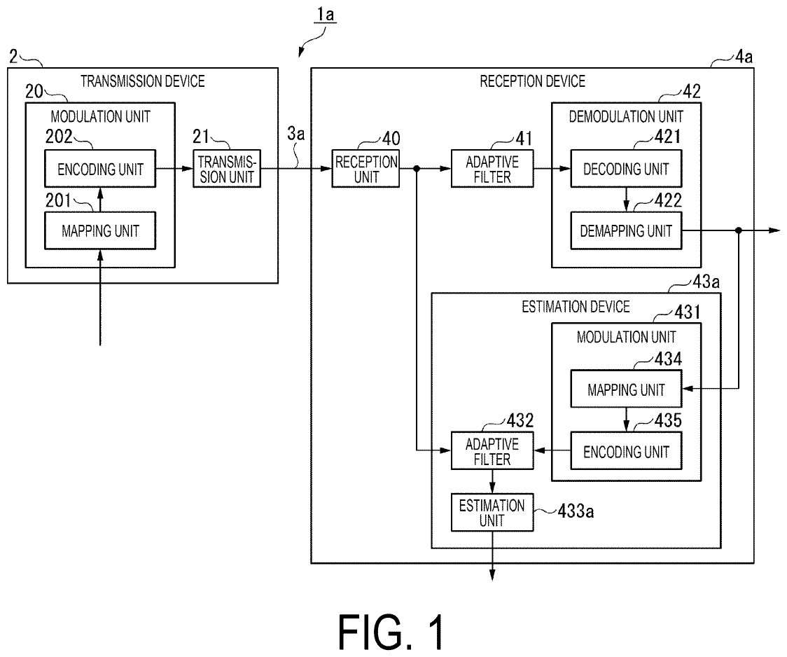

FIG. 1 is a diagram illustrating a configuration example of a communication system 1a according to a first embodiment. The communication system 1a is a system that performs communication using an optical signal. The communication system 1a includes a transmission device 2, an optical transmission line 3a, and a reception device 4a.

The reception device 4a converts the optical signal from the transmission device 2 into a first reception signal (electrical signal). The reception device 4a executes adaptive filter processing for the converted first reception signal. The reception device 4a generates a second reception signal (reception signal after demodulation) by executing demodulation processing for the first reception signal (reception signal before demodulation) for which the adaptive filter processing has been executed.

The reception device 4a (estimation device) executes modulation processing for the second reception signal. The reception device 4a executes the adaptive filter processing (backward direction) for the second reception signal (reception signal with reduced noise) for which the modulation processing has been executed where the first reception signal (reception signal before demodulation) including noise is set as a convergence target. The reception device 4a updates a tap coefficient of the adaptive filter processing such that the second reception signal for which the adaptive filter processing (backward direction) has been executed matches the first reception signal including noise. That is, the reception device 4a converges the tap coefficient of the adaptive filter processing such that the second reception signal with reduced noise matches the first reception signal including noise. In this manner, the reception device 4a converges the tap coefficient in the backward direction.

The reception device 4a may sequentially derive a convergence solution by an algorithm using a minimal mean square error, or may derive a convergence solution at a time by an algorithm using a Wiener filter, a Kalman filter, or the like.

Since the tap coefficient of an adaptive filter approximates an inverse function of a transfer function of an optical transmission system, the reception device 4a estimates the differential group delay (DGD) and the polarization dependent loss (PDL) on the basis of the updated tap coefficient.

The transmission device 2 includes a modulation unit 20 and a transmission unit 21. The modulation unit 20 (first modulation unit) includes a mapping unit 201 and an encoding unit 202. The optical transmission line 3a includes an optical fiber.

The mapping unit 201 executes predetermined symbol mapping processing for digital data to be transmitted. The encoding unit 202 executes predetermined encoding processing for a result of the symbol mapping processing. For example, the encoding unit 202 adds an error correction code to the result of the symbol mapping processing. The transmission unit 21 generates an optical signal according to the result of the symbol mapping processing. The transmission unit 21 outputs the optical signal to the optical transmission line 3a. The optical transmission line 3a includes a single mode fiber. The optical transmission line 3a transmits the optical signal.

The reception device 4a includes a reception unit 40, an adaptive filter 41, a demodulation unit 42, and an estimation device 43a. The demodulation unit 42 includes a decoding unit 421 and a demapping unit 422. The estimation device 43a includes a modulation unit 431, an adaptive filter 432, and an estimation unit 433a. The modulation unit 431 (second modulation unit) includes a mapping unit 434 and an encoding unit 435.

The reception unit 40 acquires the optical signal transmitted through the optical transmission line 3a. The transmitted optical signal may include noise. The reception unit 40 converts the acquired optical signal into a reception signal (electrical signal). The adaptive filter 41 is, for example, a minimal mean square error filter (MMSE filter). The adaptive filter 41 executes the adaptive filter processing for the reception signal converted from the acquired optical signal.

The decoding unit 421 executes predetermined decoding processing for the reception signal for which the adaptive filter processing has been executed. For example, the decoding unit 421 executes error correction processing using the error correction code. The demapping unit 422 executes predetermined symbol demapping processing for the reception signal for which the decoding processing has been executed.

The mapping unit 434 acquires the reception signal for which the symbol demapping processing has been executed from the demapping unit 422. The mapping unit 434 executes predetermined symbol mapping processing for the reception signal for which the symbol demapping processing has been executed. The encoding unit 435 executes predetermined encoding processing for the reception signal for which the symbol mapping processing has been executed. As a result, the encoding unit 435 generates the reception signal with reduced noise. For example, the encoding unit 435 adds the same error correction code as the error correction code added to the transmission signal by the encoding unit 202 to the reception signal for which the symbol mapping processing has been executed.

The adaptive filter 432 is, for example, a minimal mean square error filter (MMSE filter). The adaptive filter 432 acquires the first reception signal including noise generated in the optical signal in the optical transmission line 3a from the reception unit 40. The adaptive filter 432 acquires the second reception signal with reduced noise from the encoding unit 435. The adaptive filter 432 executes the adaptive filter processing for the second reception signal (reception signal with reduced noise) for which the modulation processing has been executed where the first reception signal (reception signal including noise) acquired from the reception unit 40 is set as the convergence target. The adaptive filter 432 updates the tap coefficient of the adaptive filter processing by the adaptive filter 432 such that the result of the adaptive filter processing executed by the adaptive filter 432 matches the first reception signal including noise.

The estimation unit 433a executes Fourier transform for the updated tap coefficient (converged tap coefficient). The result “W (w)” of the Fourier transform is expressed as Equation (1).

$$\begin{matrix}[ Math . 1 ] & \\ W ( ω ) = [ \begin{matrix}{h}_{xx} ( ω ) & {h}_{xy} ( ω ) \\ {h}_{yx} ( ω ) & {h}_{yy} ( ω )\end{matrix} ] & ( 1 )\end{matrix}$$

Here, “ω” represents a sampling frequency. An estimated value “τₑₛₜᵢₘ(w)” of the differential group delay (DGD) is expressed by Equation (2).

$$\begin{matrix}[ Math . 2 ] & \\ {τ}_{estim} ( ω ) = 2 \sqrt{\frac{det ( \frac{dW ( ω )}{d ω} )}{det W ( ω )}} & ( 2 )\end{matrix}$$

Furthermore, an estimated value “H_{PDL}(ω)” of the polarization dependent loss (PDL) is expressed as Equation (3) (Reference Literature 1: F. N. Hauske, et al., “Optical Performance Monitoring in Digital Coherent Receivers” Journal of Lightwave Technology, vol. 27, no. 16, pp. 3623-3631 Aug. 2009).

$$\begin{matrix}[ Math . 3 ] & \\ {H}_{PDL} ( ω ) = \vert \sqrt{det W ( ω )} \vert & ( 3 )\end{matrix}$$

The convergence solution “H_{wiener}(ω)” of the minimal mean square error algorithm is called Wiener solution. The Wiener solution is expressed as Equation (4).

$$\begin{matrix}[ Math . 4 ] & \\ {H}_{wiener} ( ω ) = \frac{{H}^{*} ( ω )}{{\vert H ( ω ) \vert}^{2} + 1 / SNR} & ( 4 )\end{matrix}$$

Here, “H(ω)” represents a transfer function of the optical transmission line. “H*(ω)” represents a complex conjugate of the transfer function. “SNR” represents a signal-to-noise ratio of the reception signal before the adaptive filter processing is executed. The Wiener solution includes a term that depends on the signal-to-noise ratio. The term depending on the signal-to-noise ratio becomes a factor of a system error in which an average value is not 0.

The second reception signal before the filter processing by the adaptive filter 432 does not include noise other than the noise due to the addition of the error correction code even if the noise due to the addition of the error correction code by the encoding unit 435 is included. Therefore, since the value of “SNR” in the denominator of Equation (4) becomes infinite and the value of “1/SNR” becomes 0, the convergence solution “H_{wiener}(ω)” does not depend on the signal-to-noise ratio. As a result, the system error can be reduced.

Next, an operation example of the communication system 1a will be described.

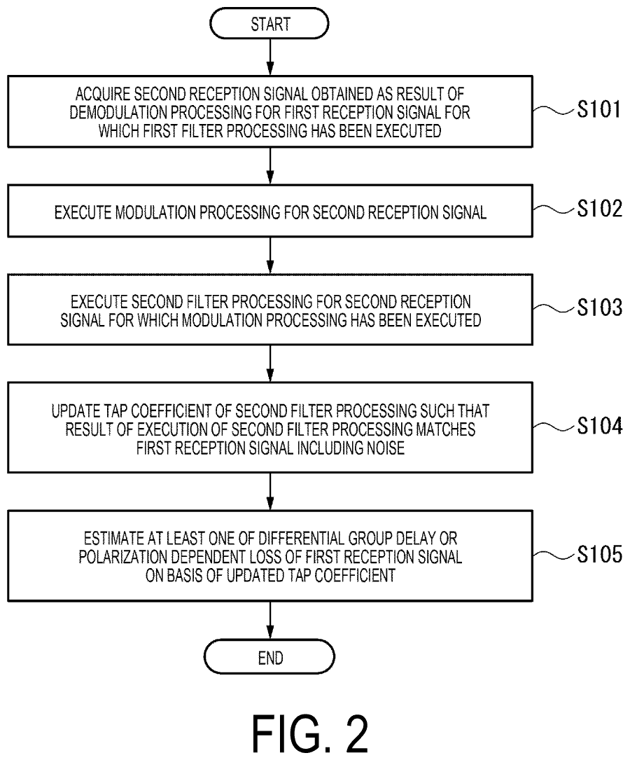

FIG. 2 is a flowchart illustrating an operation example of the communication system 1a in the first embodiment. The modulation unit 431 acquires, from the demodulation unit 42, the second reception signal obtained as a result of the demodulation processing for the first reception signal for which first filter processing has been executed by the adaptive filter 41 (step S101). The modulation unit 431 executes modulation processing similar to the modulation processing executed by the modulation unit 20 for the acquired second reception signal (step S102).

The adaptive filter 432 executes second filter processing for the second reception signal for which the modulation processing has been executed (step S103). The adaptive filter 432 updates the tap coefficient of the second filter processing such that the result of the execution of the second filter processing matches the first reception signal including noise (step S104). The estimation unit 433a estimates at least one of the differential group delay (DGD) or the polarization dependent loss (PDL) of the first reception signal on the basis of the updated tap coefficient (step S105).

Note that the reception device 4a may generate the reception signal with reduced noise by the reception device 4a converting an unknown transmission signal into the reception signal, and the reception device 4a adding the error correction code to the converted reception signal.

Further, the reception device 4a may omit the processing of generating the reception signal with reduced noise (addition of the error correction code) by converting the reception signal from a known transmission signal.

As described above, the modulation unit 20 (first modulation unit) outputs the optical signal for which the modulation processing has been executed to the optical transmission line 3a via the transmission unit 21. The adaptive filter 41 (first adaptive filter) executes the first filter processing for the first reception signal including noise generated in the optical signal in the optical transmission line 3a. The demodulation unit 42 executes the demodulation processing for the first reception signal for which the first filter processing has been executed. The modulation unit 431 (second modulation unit) executes the modulation processing similar to the modulation processing executed by the modulation unit 20 for the second reception signal obtained as a result of the demodulation processing for the first reception signal for which the first filter processing has been executed. The adaptive filter 432 (second adaptive filter) updates the tap coefficient of the second filter processing such that the result of execution of the second filter processing for the second reception signal for which the modulation processing has been executed matches the first reception signal including noise. The estimation unit 433a estimates at least one of the differential group delay or the polarization dependent loss of the first reception signal on the basis of the updated tap coefficient.

When a filter coefficient (tap coefficient) used for estimating the differential group delay and the polarization dependent loss of the optical signal transmitted through the optical transmission line is estimated, the adaptive filter 432 converges the filter coefficient (tap coefficient) of the second filter processing for the second reception signal in the backward direction to the noise reduction processing for the first reception signal obtained from the transmission device 2 (that is, in such a way that the second reception signal with reduced noise matches the first reception signal including noise).

As a result, even in the case where the reception signal includes noise, it is possible to improve the estimation accuracy of at least one of the differential group delay or the polarization dependent loss.

### (Simulation Results)

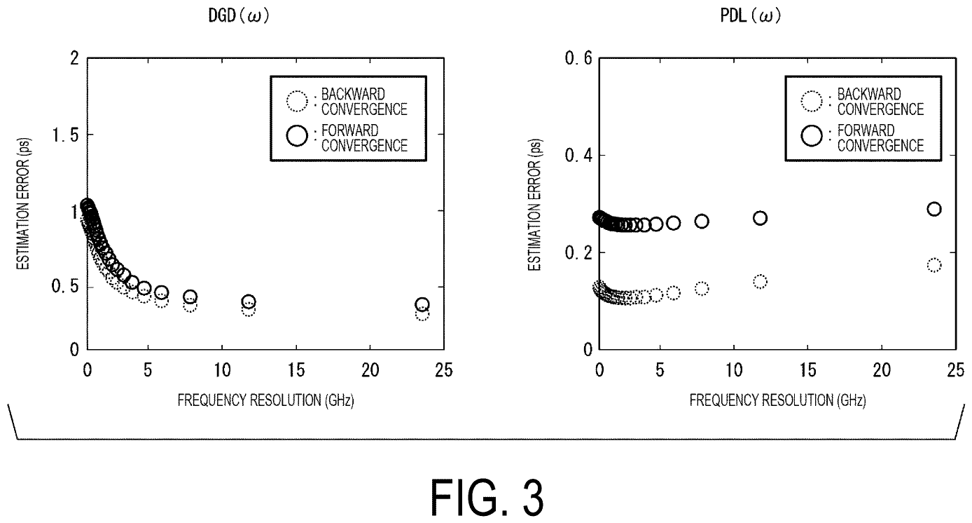

FIG. 3 is graphs illustrating an example of a simulation result of the differential group delay (DGD) and the polarization dependent loss (PDL) in the first embodiment. The horizontal axis represents a frequency resolution of a low-pass filter applied to the simulation result (measurement result). The vertical axis represents a standard deviation of an estimation error. A dot of “forward convergence” represents an error of an estimated value by a conventional method to be compared. A dot of “backward convergence” represents an error of an estimated value in the first embodiment.

A transmission rate of a polarization multiplexed signal is, for example, 96 GBaud. A modulation scheme of the polarization multiplexed signal is, for example, 16 quadrature amplitude modulation (16QAM). A length of the optical transmission line is, for example, 1800 km. Polarization mode dispersion (PMD) of the optical transmission line is, for example, 0.1 ps/km^{1/2}. An average value of the polarization dependent loss (PDL) of the optical transmission line is, for example, 5 dB.

In the simulation, a state (parameter) of the optical transmission line was randomly updated 50 times. The estimation unit 433a estimated the differential group delay (DGD) and the polarization dependent loss (PDL) that were frequency-resolved by an adaptive filter with a “2×2 MIMO” configuration. In addition, a one-dimensional low-pass filter is applied as a smoothing filter for comparison with a conventional smoothing filter technique. In addition, a theoretical value of the frequency resolution after the filter application was derived as an index of smoothing strength, so that a relationship between the frequency resolution and the estimation error was measured. In this way, the standard deviation of the estimation error of the differential group delay (DGD) and the standard deviation of the estimation error of the polarization dependent loss (PDL) were measured.

For both the differential group delay (DGD) and the polarization dependent loss (PDL), the estimated values obtained in the first embodiment showed higher accuracy. Although noise reduction efficiency by the smoothing filter is lower than the estimation of the differential group delay, the estimation value obtained in the first embodiment showed higher accuracy in the estimation of the polarization dependent loss.

### Second Embodiment

In a second embodiment, a main difference from the first embodiment is that an optical transmission line is a spatial multiplexing fiber. In the second embodiment, differences from the first embodiment will be mainly described.

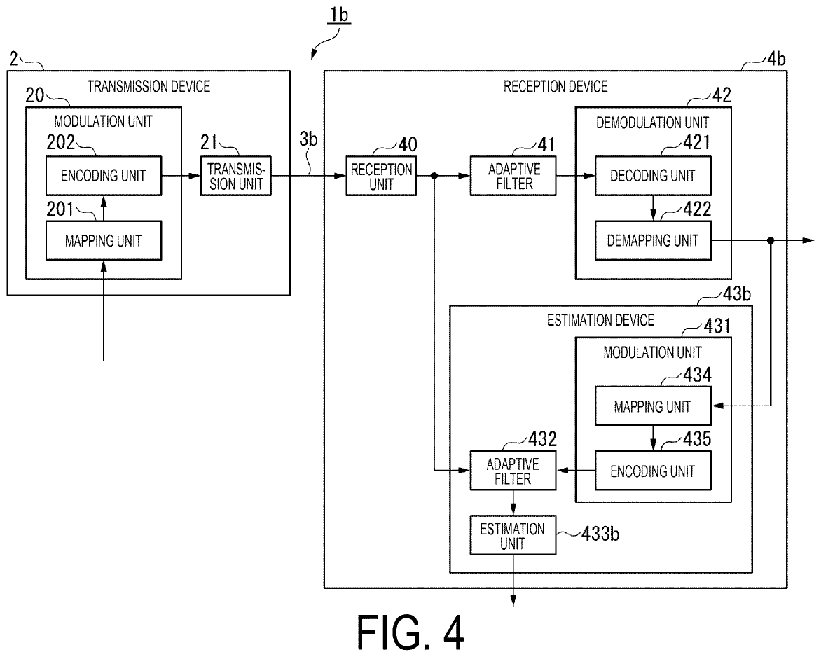

FIG. 4 is a diagram illustrating a configuration example of a communication system 1b in the second embodiment. The communication system 1b is a system that performs communication using an optical signal. The communication system 1b includes a transmission device 2, an optical transmission line 3b, and a reception device 4a.

The transmission device 2 includes a modulation unit 20 and a transmission unit 21. The modulation unit 20 includes a mapping unit 201 and an encoding unit 202.

The optical transmission line 3b includes a spatial multiplexing fiber. The spatial multiplexing fiber is, for example, a multi-core fiber, a multi-mode fiber, or a multi-core/multi-mode fiber. The optical transmission line 3b transmits the optical signal.

The reception device 4b includes a reception unit 40, an adaptive filter 41, a demodulation unit 42, and an estimation device 43b. The demodulation unit 42 includes a decoding unit 421 and a demapping unit 422. The estimation device 43b includes a modulation unit 431, an adaptive filter 432, and an estimation unit 433b. The modulation unit 431 includes a mapping unit 434 and an encoding unit 435.

The reception device 4b accurately estimates at least one of a differential mode delay (DMD) or a mode dependent loss (MDL) of the optical transmission line 3b including the spatial multiplexing fiber.

In a case where polarization degrees of freedom and spatial degrees of freedom are multiplexed by “N” in total in the spatial multiplexing fiber, the reception device 4b includes the adaptive filter 41 and the adaptive filter 432 of an “N×N MIMO configuration” instead of respective adaptive filters of a “2×2 MIMO configuration”. The reception device 4b converges a tap coefficient of the adaptive filter in a backward direction similarly to the first embodiment.

The reception device 4b may sequentially derive a convergence solution by an algorithm using a minimal mean square error, or may derive a convergence solution at a time by an algorithm using a Wiener filter, a Kalman filter, or the like. The estimation unit 433b converts a result of a Fourier transform of the converged tap coefficient into a matrix “W (w)” of “N×N”. The estimation unit 433b derives eigenvalues of the matrix exemplified in Expression (5).

$$\begin{matrix}[ Math . 5 ] & \\ i \frac{dW}{d ω} {W ( ω )}^{†} & ( 5 )\end{matrix}$$

The estimation unit 433b derives a difference between the eigenvalues as a differential mode delay difference (DMD). The estimation unit 433b derives a ratio between singular values of the matrix “W (w)” as a mode dependent loss (MDL) (Reference Literature 2: K. P. Ho and J. M. Kahn, “Mode-dependent loss and gain: statistics and effect on mode-division multiplexing” Optics Express, vol. 19, no. 17, pp. 16612-16635, August 2011).

Note that the reception device 4b may generate a reception signal with reduced noise by the reception device 4b converting an unknown transmission signal into the reception signal, and the reception device 4b adding an error correction code to the converted reception signal.

Further, the reception device 4b may omit the processing of generating the reception signal with reduced noise (addition of the error correction code) by converting the reception signal from a known transmission signal.

As described above, the estimation unit 433b estimates at least one of the differential group delay or the polarization dependent loss of a first reception signal on the basis of the updated tap coefficient. The estimation unit 433b may further estimate at least one of the differential mode delay or the mode dependent loss of the optical transmission line.

As a result, even in a case where the reception signal transmitted through the spatial multiplexing fiber includes noise, it is possible to improve estimation accuracy of at least one of the differential group delay or the polarization dependent loss. In addition, it is possible to improve the estimation accuracy of at least one of the differential mode delay or the mode dependent loss. The estimation unit included in the device of the present invention can also be implemented by a computer and a program, and the program can be recorded in a recording medium or provided through a network.

### (Hardware Configuration Example)

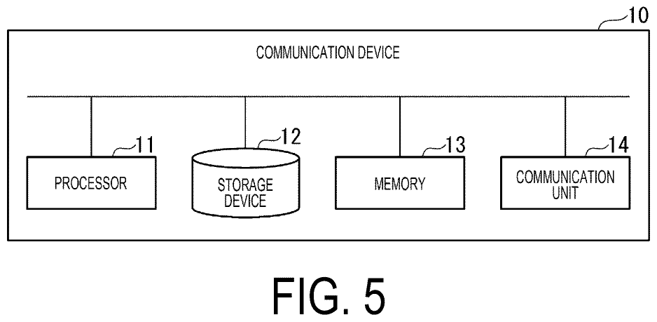

FIG. 5 illustrates a hardware configuration example of a communication device in each embodiment. The hardware configuration example of a communication device 10 corresponds to the hardware configuration example of the transmission device 2 of each embodiment, the hardware configuration example of the reception device 4a of the first embodiment, and the hardware configuration example of the reception device 4b of the second embodiment.

Some or all of the functional units of the communication device 10 are realized as software by causing a processor 11 such as a central processing unit (CPU) to execute a program stored in a storage device 12 including a non-volatile recording medium (non-transitory recording medium) and a memory 13. The program may be recorded on a computer-readable recording medium. The computer-readable recording medium is, for example, a portable medium such as a flexible disk, a magneto-optical disc, a read-only memory (ROM), or a compact disc read-only memory (CD-ROM), or a non-transitory recording medium such as a storage device such as a hard disk built in a computer system. The communication unit 14 acquires tap coefficient information and the like. The communication unit 14 transmits the estimation result to a predetermined information processing device (not illustrated).

Some or all of the functional units of the communication device 10 may be realized by using, for example, hardware including an electronic circuit (or circuitry) by using a large scale integrated circuit (LSI), an application specific integrated circuit (ASIC), a programmable logic device (PLD), a field programmable gate array (FPGA), or the like.

Although the embodiments of the present invention have been described in detail with reference to the drawings, a specific configuration is not limited to the embodiments, and includes design and the like without departing from the spirit of the present invention.

### INDUSTRIAL APPLICABILITY

The present invention is applicable to an optical measurement device and an optical communication system using digital coherent reception.

### REFERENCE SIGNS LIST

1a, 1b Communication system
2 Transmission device
3a, 3b Optical transmission line
4a, 4b Reception device
10 Communication device
11 Processor
12 Storage device
13 Memory
14 Communication unit
20 Modulation unit
21 Transmission unit
201 Mapping unit
40 Reception unit
41 Adaptive filter
42 Demodulation unit
43a, 43b Estimation device
421 Decoding unit
422 Demapping unit
431 Modulation unit
432 Adaptive filter
433a, 433b Estimation unit
434 Mapping unit
435 Encoding unit

1. A communication system comprising: a transmission device and a reception device,
the transmission device including
a first modulator configured to output an optical signal for which modulation processing has been executed to an optical transmission line, and
the reception device including
a first adaptive filter configured to execute first filter processing for a first reception signal including noise generated in the optical signal in the optical transmission line,
a demodulator configured to execute demodulation processing for the first reception signal for which the first filter processing has been executed,
a second modulator configured to execute the modulation processing for a second reception signal obtained as a result of the demodulation processing for the first reception signal for which the first filter processing has been executed,
a second adaptive filter configured to update a tap coefficient of the second filter processing such that a result obtained by executing second filter processing for the second reception signal for which the modulation processing has been executed matches the first reception signal including the noise, and
an estimator configured to estimate at least one of a differential group delay or a polarization dependent loss of the first reception signal on a basis of the updated tap coefficient.

2. The communication system according to claim 1, wherein the estimator further estimates at least one of a differential mode delay or a mode dependent loss of the optical transmission line.

3. An estimation device comprising:
a modulator configured to execute the modulation processing for a second reception signal obtained as a result of the demodulation processing for the first reception signal for which the first filter processing has been executed;
a second adaptive filter configured to update a tap coefficient of the second filter processing such that a result obtained by executing second filter processing for the second reception signal for which the modulation processing has been executed matches the first reception signal including the noise; and
an estimator configured to estimate at least one of a differential group delay or a polarization dependent loss of the first reception signal on a basis of the updated tap coefficient.

4. An estimation method executed by a communication system including a transmission device and a reception device, the communication method comprising:
by the transmission device,
outputting an optical signal for which modulation processing has been executed to an optical transmission line; and
by the reception device,
executing first filter processing for a first reception signal including noise generated in the optical signal in the optical transmission line;
executing demodulation processing for the first reception signal for which the first filter processing has been executed;
executing the modulation processing for a second reception signal obtained as a result of the demodulation processing for the first reception signal for which the first filter processing has been executed;
updating a tap coefficient of the second filter processing such that a result obtained by executing second filter processing for the second reception signal for which the modulation processing has been executed matches the first reception signal including the noise; and
estimating at least one of a differential group delay or a polarization dependent loss of the first reception signal on a basis of the updated tap coefficient.
